(19) United States
(12) Patent Application Publication
(10) Pub. No.: US 2006/0132829 A1
(43) Pub. Date: Jun. 22, 2006

(54) Multi-function imaging machine with fax settings lock

(75) Inventors: Larry J. Dicken, Lexington, KY (US); Timothy A. May, Lexington, KY (US); Duane E. Norris, Richmond, KY (US); Stephen R. Troyer, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/015,204

(22) Filed: Dec. 17, 2004

(51) Int. Cl. G06F 3/12

(52) U.S. Cl. 358/1.15

(57) ABSTRACT

In a system comprising a computer in communication with a multi-function imaging machine having a printer section and a fax section, and a user input device, a method of operating the multi-function imaging machine, comprising the steps of setting one or more fax settings; providing a fax settings lock for user selection; and locking fax settings for said fax section using said fax settings lock when selected. The fax settings, which include at least one of speed dial settings, group settings and junk fax list, can be provided for viewing on the computer as read-only values while allowing for additions to said speed dial settings, group settings and junk fax list from said computer.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates to multi-function imaging machines, and, more particularly, to configuring fax settings in a multi-function imaging machine.

2. Description of the Related Art

Computer peripheral equipment provides various desired functionality to an attached computer, such as faxing, scanning, printing, copying, etc. To save space, cost, etc., it has become more common to include multiple functions in a single peripheral device. These are often referred to as multi-function machines (MFM) or all-in-one machines (AIO), which terms are used interchangeably herein. Some of the multi-function machines provide the ability to send and receive faxes.

Fax and modem settings can be configured from both the multi-function machine user interface as well as from the personal computer (PC) using software that is packaged with the multi-function machine. For some AIO machines configuration of the modem from the PC is supported only for locally. However, it is possible to support fax/modem configuration over a network connection as well as over a USB connection. In other words, for a network-attached multi-function machine, the user can configure the multi-function machine fax settings over the network from the PC or workstation. Unlike the USB-attached environment, where the multi-function machine is singularly attached to one PC, in a network-attached environment the multi-function machine is available to multiple PC users at the same time. Any user can configure and re-configure the multi-function machine modem settings, speed dial, group dial and junk fax lists. In this type of environment, the risk of setting conflicting options and inadvertent modification or deletion of the various speed dial lists is far greater than in the local attached environment.

What is needed in the art is a method of controlling access to fax settings when a multi-function machine is attached to multiple computers over a network.

### SUMMARY OF THE INVENTION

The present invention provides a multi-function machine which addresses a multi-user scenario by creating a new PC/MFM interface and an associated configuration feature that can be set only from the key panel of the MFM. This interface/feature provides for the enabling/disabling of a new option, i.e., the fax settings lock. When the fax settings lock is enabled, fax settings are protected from updates by any attached PC but new entries can be made to speed dial lists, group settings and junk fax lists but existing entries are protected from alteration. The setting is accessible to the host PC through the host/AIO command interface, but only as a read-only value.

The invention comprises, in one form thereof, in a system comprising a computer in communication with a multi-function imaging machine having a printer section and a fax section, and a user input device, a method of operating the multi-function imaging machine, comprising the steps of: selecting one or more fax settings, providing a fax settings lock for user selection; and locking fax settings for said fax section using said fax settings lock when selected.

The invention comprises, in another form thereof, in a system comprising a computer in communication via a network connection with a multi-function imaging machine having a printer section and a fax section, and a user input device, a method of operating the multi-function imaging machine, comprising the steps of: providing a fax settings lock for user selection accessible through said user input device; locking fax settings for said fax section using said fax settings lock when selected preventing changes to the fax settings from the computer when the fax settings lock is enabled and displaying and said locked fax settings on said computer as read only values.

With the present invention multiple users of computers attached to the MFM are prevented from setting conflicting fax settings. Also inadvertent modifications or deletions of fax settings by multiple users are inhibited. Further, the fax settings lock can work with a network or locally attached computer.

### BRIEF DESCRIPTION OF THE DRAWINGS

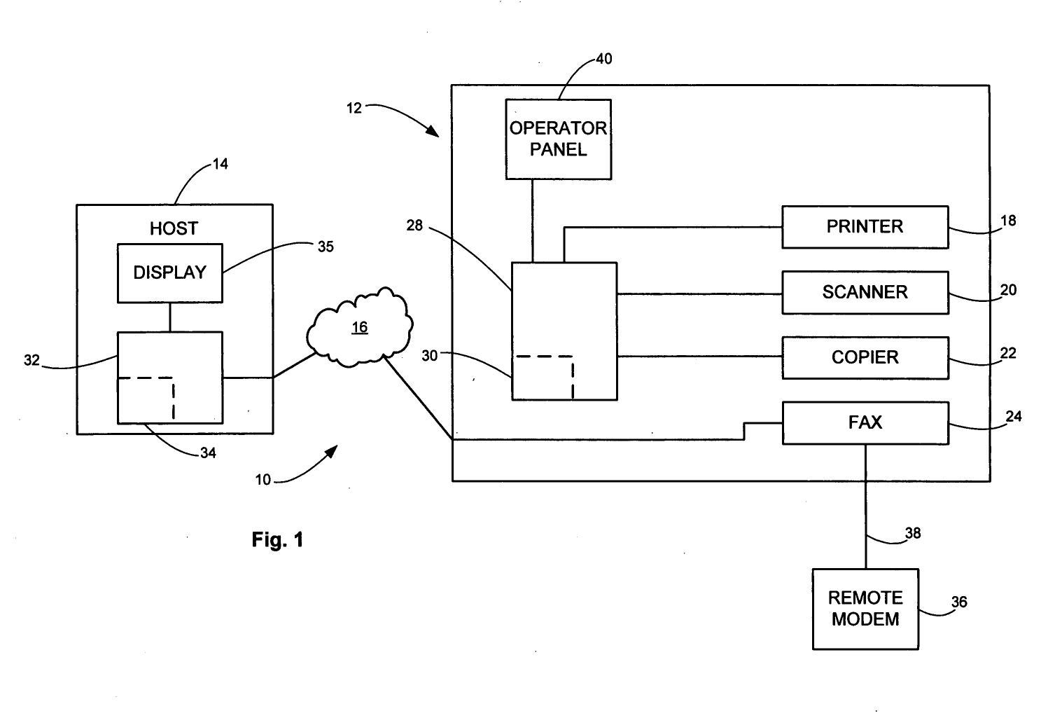

The above-mentioned and other features and advantages of this invention, and the manner of attaining them, will become more apparent and the invention will be better understood by reference to the following description of an embodiment of the invention taken in conjunction with the accompanying drawing, wherein FIG. 1 is a schematic representation of a multi-function imaging system which can be used to carry out an embodiment of a method of the present invention for operating a multi-function imaging machine. The exemplification set out herein illustrates one preferred embodiment of the invention, in one form, and such exemplification is not to be construed as limiting the scope of the invention in any manner.

### DETAILED DESCRIPTION OF THE INVENTION

Referring now to FIG. 1, there is shown an embodiment of a multi-function imaging system 10 which may be used to carry out an embodiment of a method of the present invention for operating a multi-function imaging machine 12. Multi-function imaging machine 12 (labeled MFM in FIG. 1) is coupled with a host PC or computer 14 via a suitable connection. In the embodiment shown, multi-function imaging machine 12 is coupled with host 14 via an Ethernet network connection 16. However, multi-function imaging machine 12 may be coupled with host PC 14 through a different type connection, depending upon the particular application, such as through a USB connection.

Multi-function imaging machine 12 includes a plurality of functional components, such as a printer section 18, scanner section 20, copier section 22 and fax section 24. Fax section 24 is assumed to have a modem incorporated therein; but may also include a separate modem electrically coupled therewith. Each of printer 18, scanner 20, copier 22 and fax 24 are coupled with a first processing circuit 28, which may include electrical hardware, firmware and/or software. First processing circuit 28 includes a buffer memory 30 as shown or is communication with a memory device for receiving and temporarily storing image data from host PC 14 and/or scanner 20, such as print image data or fax image data.

Multi-function machine 12 also includes an input device, e.g., an operator panel 40, which is connected with first processing circuit 28. Operator panel 40 is typically located on the front panel of multi-function machine 12 and allows a user to access various settings within multi-function machine 12. The operator panel 40, under the control of the first processing circuit 28, can include a graphic display along with control button panel. The graphic display can also be used to present selections to a user which can be selected using a control button or by use of touch screen areas on the graphic display. In addition the function labels for the control button can also be displayed on the graphic display allowing them to be programmable.

Host PC 14 includes a second processing circuit 32, typically a microprocessor based circuit, which carries out usual processing functions on host PC 14. Second processing circuit 32 is shown in FIG. 1 as being coupled in a manner that allows direct or indirect communication with either first processing circuit 28 or fax section 24. Second processing circuit 32 includes a buffer memory 34 as shown or is communication with a memory device for storing image data to be transferred to buffer memory 30 in a batch or trickle manner. Host PC 14 also can include a display 35 in communication with second processing circuit 32.

Fax section 24 may be coupled via its internal modem with a destination/remote modem 36 via a suitable connection line 38, such as a telephone line or through a network. Connection line 38 preferably allows two-way communication with remote modem 36, such as transmitting fax data and receiving a query response.

Operator panel 40 provides access to various features, settings, etc. within multi-function machine 12. For example, operator panel 40 can be used to set the fax settings associated with fax section 24. The fax settings may include, e.g., modem settings, speed dial settings, group settings and junk fax lists associated with fax section 24. When connected through network connection 16, there is also the possibility as described above that multiple users can set conflicting fax settings, or inadvertently change or delete the fax settings. Operator panel 40 therefore also includes a “fax settings lock” feature that can be accessed by a user. In the embodiment described, the fax settings lock is embodied in software either within fax section 24 or first processing circuit 28.

When enabled, the fax settings lock prevents changing fax settings for fax section 24 from host computer 14, but allows changing fax settings for fax section 24 from operator panel 40. The fax settings lock does not allow changes to existing fax settings from host computer 14, but does allow new entries to be added to the speed dial settings, group settings and junk fax lists but does not allow existing entries to be altered. Host computer 14 includes a display 35, as is common, and the locked fax settings are viewable on the display as read only values.

In another embodiment, connection 16 between multi-function machine 12 and host PC 14 is a local connection, such as a USB connection. When coupled together in a local manner, the fax settings lock can still be incorporated into multi-function machine 12, but treated in different ways depending upon the application, namely:

1. the fax settings lock can be ignored and fax settings for fax section 24 can be changed from host PC 14;

2. the fax setting lock is not allowed as a configuration option and is not displayed or is grayed out on the display; or

3. the fax settings lock is enabled and fax settings for fax section 24 cannot be changed from host PC 14.

It will also be appreciated that it is possible to sense the connection type between multi-function machine 12 and host PC 14, e.g., a network connection or a USB connection. Thus, the decision making process described immediately above for the situation where a local connection is present can be pre-programmed into multi-function machine 12.

In the embodiments described above, the fax settings lock is enabled and disabled through the use of key panel 40. However, it will also be appreciated that the fax settings lock can be enabled and disabled through a network attached host PC 14. For example, the software can be configured to require administrator level access to enable and disable the fax settings lock.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. In a system comprising a computer in communication with a multi-function imaging machine having a printer section and a fax section, and a user input device, a method of operating the multi-function imaging machine, comprising the steps of:
setting one or more fax settings;
providing a fax settings lock for user selection; and
locking fax settings for said fax section using said fax settings lock when selected.

2. The method of operating a multi-function imaging machine of claim 1, wherein said multi-function machine is coupled to said computer through a network connection, and said fax settings lock prevents changing fax settings for said fax section from said computer.

3. The method of operating a multi-function imaging machine of claim 2, wherein said fax settings lock when selected prevents changing fax settings for said fax section from said computer while allowing changes to fax settings for said fax section from said user input device.

4. The method of operating a multi-function imaging machine of claim 3, wherein said computer includes a display, and the method further comprises displaying said locked fax settings on said display as read only values.

5. The method of operating a multi-function imaging machine of claim 3, wherein said fax settings include at least one of modem settings, speed dial settings, group settings and junk fax lists, and the method further comprises allowing new entries to be added to said speed dial settings, group settings and junk fax lists from said computer.

6. The method of operating a multi-function imaging machine of claim 1, wherein said fax settings lock comprises a software lock.

7. The method of operating a multi-function imaging machine of claim 6, wherein said fax settings include at least one of modem settings, speed dial settings, group settings and junk fax lists.

8. The method of operating a multi-function imaging machine of claim 1, wherein said user input device includes a operator panel having one of a control button panel, a graphic display, a combination of a control button panel and a graphic display.

9. The method of operating a multi-function imaging machine of claim 1, wherein said multi-function machine is in communication with said computer through a local host connection, and said fax settings lock is one of:
ignored and fax settings for said fax section can be changed from said computer via said local host connection;
not presented as a user-selectable configuration option on said computer via said local host connection; and
enabled and fax settings for said fax section cannot be changed from said computer via said local host connection.

10. The method of operating a multi-function imaging machine of claim 1, including the step of sensing whether said multi-function machine is in communication with said computer through one of a network connection and a local host connection.

11. The method of operating a multi-function imaging machine of claim 1, wherein said step of locking said fax settings lock includes using one of said user input device on said multi-function machine, and software on said computer.

12. The method of operating a multi-function imaging machine of claim 1, wherein said multi-function machine includes a scanner section and a copier section.

13. In a system comprising a computer in communication via a network connection with a multi-function imaging machine having a printer section and a fax section, and a user input device, a method of operating a multi-function imaging machine, comprising the steps of:
providing a fax settings lock;
enabling said fax settings lock; and
preventing changes to said fax settings from said computer when said fax settings lock is enabled.

14. The method of operating a multi-function imaging machine of claim 13, wherein said multi-function machine includes a user input device, and including the step of allowing changes to said fax settings from said user input device when said fax settings lock is enabled.

15. The method of operating a multi-function imaging machine of claim 14, wherein said computer includes a display, and the method further comprises displaying said fax settings on said display as read only values.

16. The method of operating a multi-function imaging machine of claim 14, wherein said fax settings include at least one of modem settings, speed dial settings, group settings and junk fax lists, and said fax settings lock does not allow changes to existing said fax settings from said computer and the method further comprises allowing new entries to be added to said speed dial settings, group settings and junk fax lists from said computer.

17. The method of operating a multi-function imaging machine of claim 14, wherein said user input device includes an operator panel having one of a control button panel, a graphic display, a combination of a control button panel and a graphic display

18. The method of operating a multi-function imaging machine of claim 13, wherein said fax settings lock comprises a software lock.

19. The method of operating a multi-function imaging machine of claim 13, wherein said fax settings include at least one of modem settings, speed dial settings, group settings and junk fax lists.

20. The method of operating a multi-function imaging machine of claim 13, wherein said step of enabling said fax settings lock includes using one of a user input device on said multi-function machine, and software on said computer.

21. The method of operating a multi-function imaging machine of claim 13, wherein said multi-function machine includes a scanner section and a copier section.

22. In a system comprising a computer in communication with a multi-function imaging machine having a printer section, a scanning section, a copier section and a fax section, and a user input device, a method of operating the multi-function imaging machine, comprising the steps of:
setting one or more fax settings, wherein said fax settings to be added to said speed dial settings, group settings and junk fax list from said computer;
providing a fax settings lock for user selection;
sensing whether said multi-function machine is in communication with said computer through one of a network connection and a local host connection; and
when the network connection is sensed, locking fax settings for said fax section using said fax settings lock when selected while allowing new entries to be added to said speed dial settings, group settings and junk fax list from said computer; and
when the local host connection is sensed, said fax settings lock is one of:
ignored and fax settings for said fax section can be changed from said computer via said local host connection;
not presented as a user-selectable configuration option on said computer via said local host connection; and
enabled and fax settings for said fax section cannot be changed from said computer via said local host connection.

23. The method of operating a multi-function imaging machine of claim 23, wherein said computer includes a display, and the method further comprises displaying said locked fax settings on said display as read only values.
